(19) United States
(12) Patent Application Publication
(10) Pub. No.: US 2013/0278862 A1
(43) Pub. Date: Oct. 24, 2013

(54) LIQUID CRYSTAL DISPLAY DEVICE

(71) Applicant: Shanghai Tianma Micro-Electronics Co., Ltd., Shanghai (CN)

(72) Inventors: Sitao Huo, Shanghai (CN); Jun Ma, Shanghai (CN)

(21) Appl. No.: 13/921,114

(22) Filed: Jun. 18, 2013

Related U.S. Application Data
(63) Continuation of application No. PCT/CN2011/080024, filed on Sep. 22, 2011.

(30) Foreign Application Priority Data
Feb. 22, 2011 (CN) 201110042229.8

(51) Int. Cl. G02F 1/1335

(52) U.S. Cl. CPC G02F 1/133514; G02F 1/133606
USPC 349/61; 349/106; 349/113

(57) ABSTRACT

A liquid crystal display device includes a plurality of pixel units. The pixel units include a reflection region and a transmission region. The space between the reflection region and the transmission region of adjacent pixel units is not more than 1 μm in the direction parallel to the substrate. The gap between adjacent pixel units is utilized. As a result, the utilization ratio of display region of the liquid crystal display device is improved, and the effective area of the reflection region is increased. Accordingly, the display quality of the reflection region is improved without decreasing the transmission region, or the effective area of the transmission region is increased and the display quality of the transmission region is improved without decreasing the reflection region. Consequently, the aperture ratio of the liquid crystal display device is effectively improved.

This application claims priority to and is a continuation of International Patent Application PCT/CN2011/080024, titled “Liquid Crystal Display Device,” filed Sep. 22, 2011, which claims priority to Chinese Patent Application No. 201110042229.8 titled “Liquid Crystal Display Device”, filed with the State Intellectual Property Office of China on Feb. 22, 2011, the contents of which are incorporated herein by reference in their entirety.

### TECHNICAL FIELD

The present invention relates to Liquid Crystal Displays, and especially to a Liquid Crystal Display (LCD) device.

### TECHNICAL BACKGROUND

In consideration of controlling both the backlight power and outdoor display characteristics, a semi-reflection and semi-transmission mode is employed in many LCD screens. This is done to achieve an effect of luminance compensation by using ambient light reflected by reflection regions. In the existing display technologies, display regions include a reflection region where the reflected ambient light is used for displaying, and a transmission region where the transmitted backlight is used for displaying. Therefore, in an environment with strong outdoor light, better display quality can be achieved by using light reflected from the reflection regions.

However, due to a limited size of the Liquid Crystal Display device, the transmission region and the reflection region are constrained by each other in the same LCD device. That is, in order to increase the transmission region, the reflection region must be accordingly reduced, which causes a decreased reflectivity of the Liquid Crystal Display device. Conversely, if the reflection region of the Liquid Crystal Display device is increased, the transmission region must be accordingly reduced, which leads to a decreased transmissivity.

### SUMMARY OF THE INVENTION

One implementation is a Liquid Crystal Display device, including an array substrate and a color film substrate. The device also includes a plurality of pixel units between the array substrate and the color film substrate, where each pixel unit includes a reflection region, and a transmission region. A distance between the reflection region of a first pixel unit and the transmission region of a pixel unit adjacent to the first pixel unit is less than or equal to 1 micrometer in a direction parallel to the array substrate.

Another implementation is a Liquid Crystal Display device, including a plurality of scanning lines and a plurality of data lines. The device also includes a plurality of pixel units formed near intersections of the scanning lines and data, where each pixel unit includes a reflection region, and a transmission region. A distance between the reflection region of a first pixel unit and the transmission region of a pixel unit adjacent to the first pixel unit is less than or equal to 1 micrometer.

### BRIEF DESCRIPTION OF THE DRAWINGS

FIG. 1 is a schematic structural view of a reflection region and a transmission region in a Liquid Crystal Display device in the prior art;

FIG. 2 is a schematic top view of an array substrate structure of the Liquid Crystal Display device according to an embodiment of the present invention;

FIG. 3 is a schematic cross-sectional view of the array substrate structure of the Liquid Crystal Display device according to the embodiment of the present invention as shown in FIG. 2 along a line A-A′; and

FIG. 4 is a schematic cross-sectional view of an array substrate structure of the Liquid Crystal Display device according to another embodiment of the present invention along a line A-A′.

### DETAILED DESCRIPTION OF PREFERRED EMBODIMENTS

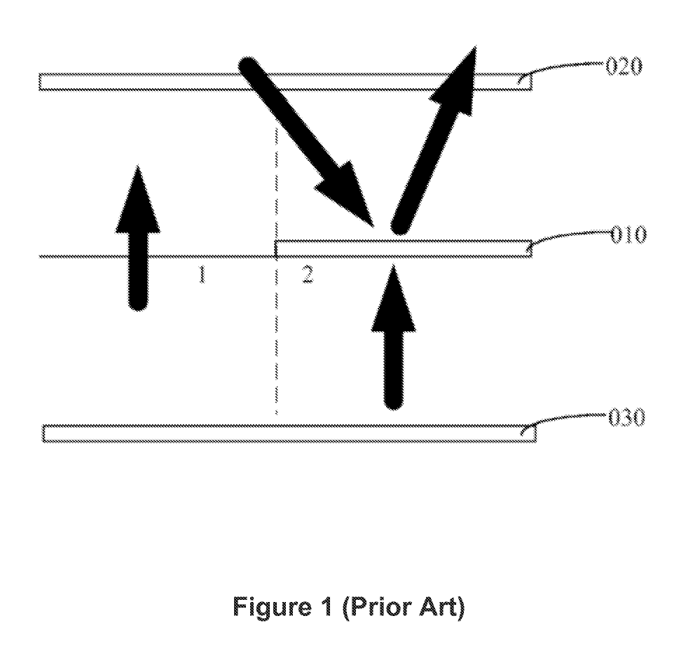

Reference is now made to FIG. 1 which shows a schematic structural view of a reflection region 2 and a transmission region 1 in the Liquid Crystal Display device in the prior art, which includes a first substrate 020 for receiving ambient light and a backlight unit 030 for providing a backlight source. The Liquid Crystal Display device is divided into a region 1 which is the transmission region and a region 2 which is the reflection region. Here, a reflection metal layer 010 is formed in the region 2, and is used to reflect the ambient light to provide a reflection display light source. The backlight source provided by the backlight unit 030 provides a light source for transmission display, to implement the semi-reflection and semi-transmission display.

However, due to the coexistence of the reflection region and the transmission region in the existing semi-reflection and semi-transmission technology, and the limitation of the size of the Liquid Crystal Display device, the reflection region and the transmission region in the same Liquid Crystal Display device are constrained by each other. That is, the reflection regions must be accordingly reduced in order to increase the transmission region, which causes a decreased reflectivity of the Liquid Crystal Display device, and conversely, the transmission region must be accordingly reduced with an increase in the reflection region in the Liquid Crystal Display device, which causes the decreased transmissivity.

In the Liquid Crystal Display device of the prior art, adjacent pixel units are electrically insulated to implement different pixel electric potentials between different pixels, and gaps between adjacent pixel units are non-display regions where neither transmission region nor reflection region is formed. For a limited area of the Liquid Crystal Display device, the display utilization of the Liquid Crystal Display device is decreased if the ratio of the non-display regions is relatively high.

In order to resolve the above problem, an embodiment of the present invention provides a Liquid Crystal Display device, which includes an array substrate, a color film substrate, and a number of pixel units between the array substrate and the color film substrate. Here, a pixel unit includes a reflection region and a transmission region, and the distance between a reflection region of a pixel unit and a transmission region of an adjacent pixel unit is not more than 1 micrometer in a direction parallel to the array substrate.

In the Liquid Crystal Display device, the display region of the pixel unit includes the reflection region and the transmission region, and the distance between the reflection region of a pixel unit and the transmission region of an adjacent pixel unit is not more than 1 micrometer. That is, the reflection region or the transmission region is formed in the gap between adjacent pixel units to almost fully utilize the gap, thereby improving the utilization of the area in the Liquid Crystal Display device. Therefore, effective areas of the reflection regions can be increased without reducing the transmission regions, to improve the display quality of the reflection regions. Alternatively, effective areas of the transmission regions can be increased without reducing the reflection regions, to improve the display quality of the transmission regions.

Certain embodiments of the present invention will be explained in detail in conjunction with the drawings and embodiments.

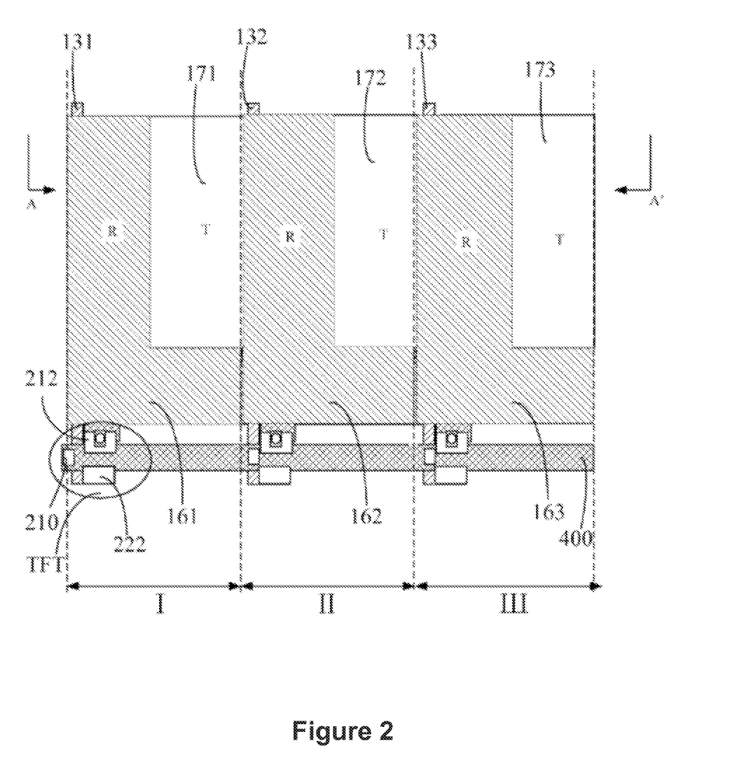

FIG. 2 shows a schematic top view of the structure of an array substrate in the Liquid Crystal Display device according to an embodiment of the present invention. Here, a first substrate which is an array substrate and a second substrate which is a color film substrate are arranged in the direction perpendicular to the drawing sheet. The structure as shown in FIG. 2 includes a number of pixel units arranged on the first substrate, i.e., the array substrate. Further, a liquid crystal molecule layer (not shown) is formed between the array substrate and the color film substrate. The liquid crystal molecule layer fills a space between the array substrate and the color film substrate.

A side of the array substrate, on which pixel units are formed, is referred to as a front side thereof, and a side opposite to the front side is a back side. A backlight source is arranged in the space facing the back side, to provide light to the pixel units from the back side of the array substrate.

Referring to FIG. 2, the Liquid Crystal Display device specifically includes: data lines 131, 132 and 133, and scanning lines 400 formed by a metal layer. The data lines and the scanning lines are arranged on the array substrate of the Liquid Crystal Display device in two directions substantially perpendicular to each other. N scanning lines and m data lines intersect each other to form N×m intersections, and N×m pixels are formed in the Liquid Crystal Display device near the intersection. FIG. 2 shows one of the scanning lines 400 which is arranged in a horizontal direction, and three of the data lines 131, 132 and 133 perpendicular to the scanning line 400. Each data line and the scanning line perpendicular to the data line define one pixel unit, for example, the data line 131 and the scanning line 400 define a first pixel unit I, the data line 132 and the scanning line 400 define a second pixel unit II, and the data line 133 and the scanning line 400 define a third pixel unit III.

The first pixel unit I, the second pixel unit II and the third pixel unit III each include switching devices which are Thin Film Transistors (TFTs) and respectively formed at intersections of the scanning line 400 and the data lines 131, 132 and 133. For example, the Thin Film Transistor of the first pixel unit I includes a gate 210, a source 222 and a drain 212. The gate 210 is connected to the scanning line 400, the source 222 is connected to the data line 131 and the drain 212 is connected to a capacitor plate (not shown) arranged on the array substrate, with the capacitor plate being electrically connected to the pixel unit. Specifically, the switching device is turned on by the gate 210 according to a signal input from the scanning line 400, and the input signal is transmitted to the drain 212, the capacitor plate connected thereto and the pixel unit via the data line 131 through the source 222. The connection relationship of the TFT of one pixel unit is hereby described, reference to which may be made for the connection relationships of other pixel units.

Further referring to FIG. 2, the pixel units of the Liquid Crystal Display device each include a reflection region R and a transmission region T, and pixel electrodes include a reflection electrode located in the reflection region R and a transmission electrode located in the transmission region T. The reflection electrodes in the reflection regions R respectively include reflection metal layers 161, 162 and 163 in this embodiment.

The reflection metal layers 161, 162 and 163 each are L-shaped. That is, each of the reflection metal layers 161, 162 and 163 includes a longitudinal reflection metal portion covering the data lines and further includes a lateral reflection metal portion. Here, a storage capacitor (not shown) is formed between the lateral reflection metal portion and the array substrate under the lateral reflection metal portion.

The transmission regions T including transparent electrodes 171, 172 and 173 are further formed in the pixel units. In this embodiment, the transparent electrodes 171, 172 and 173 comprise indium tin oxide. Light from the backlight unit is received and transmitted by the transmission regions T, and then received by the color film substrate for the display of the Liquid Crystal Display.

In a direction parallel to the array substrate, a distance between the transmission region T of the first pixel unit I and the reflection region R of the adjacent second pixel unit II is not more than 1 micrometer, and a distance between the transmission region T of the second pixel unit II and the reflection region R of the third pixel unit III is not more than 1 micrometer. That is, the distance between the reflection region R of a pixel unit and the transmission region T of an adjacent pixel unit is not more than 1 micrometer, and such distance may be even as small as 0 micrometer.

In the embodiment of the present invention, since the distance between the reflection region R of a pixel unit and the transmission region T of an adjacent pixel unit is very small, that is, the transmission regions T or the reflection regions R may be formed in the gap between adjacent pixel units, non-display regions are very limited, and may even non exist if such distance is 0 micrometer, so that effective display regions of the Liquid Crystal Display device can be greatly increased to improve the aperture ratio of the Liquid Crystal Display device effectively.

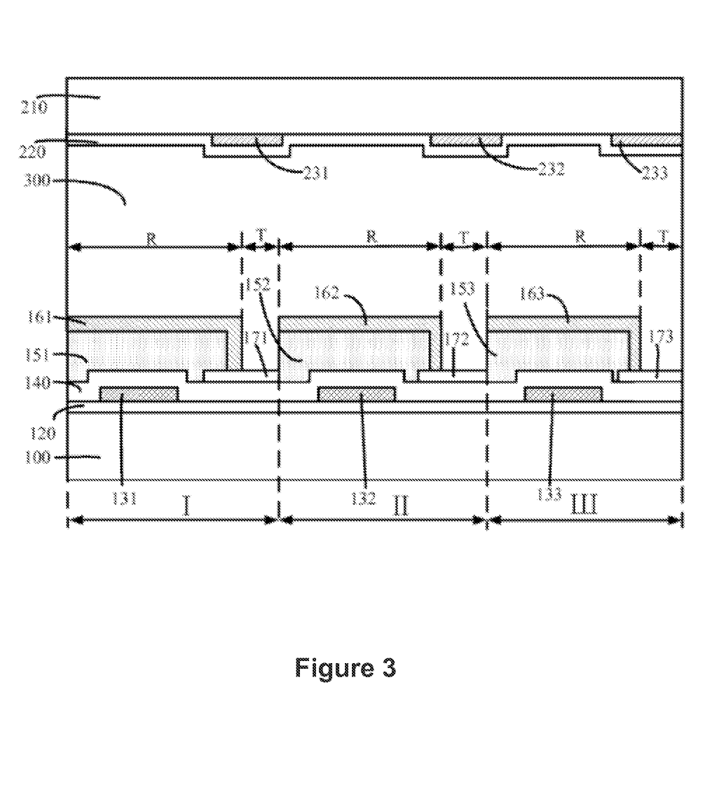

FIG. 3 is a schematic diagram of the Liquid Crystal Display device, including a sectional view of the array substrate structure shown in FIG. 2 along the line A-A′. The Liquid Crystal Display device includes an array substrate 100, a color film substrate 210 and a liquid crystal molecule layer 300 located between the array substrate 100 and the color film substrate 210. Liquid crystal molecules (not shown) are included in the liquid crystal molecule layer 300, and are modified in response to a voltage applied between the array substrate 100 and the color film substrate 210 to achieve the display function.

Referring to FIG. 3, the Liquid Crystal Display device further includes a first insulation layer 120 located on the array substrate 100, and data lines 131, 132 and 133 located on the first insulation layer 120. The pixel units corresponding to the data lines 131, 132 and 133 are the first pixel unit I, the second pixel unit II and the third pixel unit III.

Further referring to FIG. 3, a second insulation layer 140 is formed on the data lines 131, 132 and 133 to cover the data lines 131, 132 and 133. In addition, the second insulation layer 140 is also formed between adjacent data lines 131, 132 and 133 for electrical insulation between data lines 131, 132 and 133 of adjacent pixel units.

Referring to FIGS. 2 and 3, a reflection region R and a transmission region T are formed in each of the first pixel unit I, the second pixel unit II and the third pixel unit III. Reflection metal layers 161, 162 and 163 are respectively formed in the reflection regions R of the first pixel unit I, the second pixel unit II and the third pixel unit III. The reflection metal layers 161, 162 and 163 may receive incident ambient light from the color film substrate 210, and reflect the light for the reflection display of the Liquid Crystal Display device.

The transparent electrodes 171, 172 and 173 are respectively formed in the transmission regions T of the first pixel unit I, the second pixel unit II and the third pixel unit III. Light provided by the backlight source can be received and transmitted by the transmission regions T, and then exit from the color film substrate 210, for the transmission display of the Liquid Crystal Display device. The transparent electrodes 171, 172 and 173 may be made of transparent tin indium oxide.

As shown in FIG. 3, the transparent electrodes 171, 172 and 173 of the transmission regions T are located on the surface of the second insulation layer 140, and third insulation layers 151, 152 and 153 are formed between the reflection metal layers 161, 162 and 163 of the reflection regions R and the second insulation layer 140, that is, the reflection metal layers 161, 162 and 163 of the reflection regions R are formed on the surfaces of the third insulation layers 151, 152 and 153, respectively.

Further, the third insulation layers 151, 152 and 153 respectively insulate the transparent electrode of respective pixel units from the reflection metal layer of adjacent pixel units. As shown in FIG. 3, the third insulation layer 152 insulates the transparent electrode 171 of the first pixel unit I from the reflection metal layer 162 of the second pixel unit II, and the third insulation layer 153 insulates the transparent electrode 172 of the second pixel unit II from the reflection metal layer 163 of the third pixel unit III.

Further referring to FIG. 3, the reflection metal layer and the transparent electrode of the same pixel unit are electrically connected. As shown in FIG. 3, the reflection metal layer 161 is electrically connected to the transparent electrode 171, the reflection metal layer 162 is electrically connected to the transparent electrode 172, and the reflection metal layer 163 is electrically connected to the transparent electrode 173.

Those pixel units adjacent in the direction of the scanning line are adjacent pixel units. And the distance, in the direction parallel to the array substrate, between the reflection metal layer of a pixel unit and the transparent electrode of its adjacent pixel unit in the direction of the scanning line is the distance between the reflection metal layer and the transparent electrode of the adjacent pixel units. This distance is also the distance between the reflection region R and the transmission region T of the adjacent pixel units. Due to the presence of the third insulation layers 151, 152 and 153, the distance between the reflection metal layer and the transparent electrode of the adjacent pixel units can be reduced, and the reflection metal layers and the transparent electrodes of adjacent pixel units are insulated in the direction perpendicular to the array substrate by the third insulation layers 151, 152 and 153. Generally, the distance between the reflection metal layer and the transparent electrode of adjacent pixel units can be less than or equal to 1 micrometer. Therefore, the effective display regions of the Liquid Crystal Display device of the embodiment of the present invention can be greatly increased, to improve the aperture ratio of the Liquid Crystal Display device effectively.

Optionally, the distance between the reflection metal layer and the transparent electrode of the adjacent pixel units can be 0, so as to maximally increase the effective display regions of the Liquid Crystal Display device, and hence improve the aperture ratio.

Further referring to FIG. 3, a first color resistor 231, a second color resistor 232, a third color resistor 233, and a transparent electrode 220 covering the first color resistor 231, the second color resistor 232, the third color resistor 233 and the surface of the color film substrate 210 are formed on the color film substrate 210 in the Liquid Crystal Display device. The first color resistor 231, the second color resistor 232 and the third color resistor 233 are respectively arranged above the transmission regions T, and light transmitted by the transmission regions T passes through the color resistors and exits from the color film substrate 210. Specifically, the color resistors receive the light transmitted by the transmission regions, so that the transmitted light may be selectively transmitted through the color resistors of the selected colors. For example, the first color resistor 231, the second color resistor 232, or the third color resistor 233 may respectively be Red, Green and Blue.

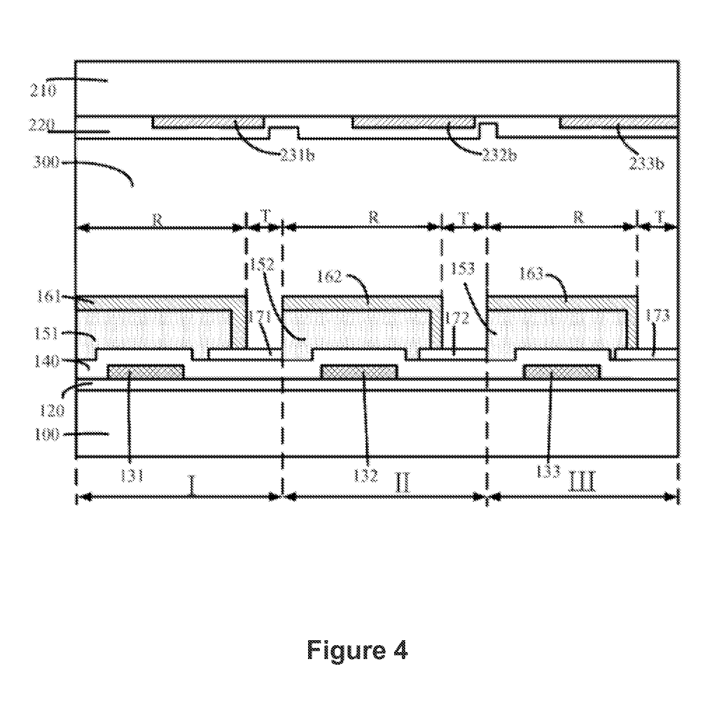

Further, the color display by both the transmission regions T and the reflection regions R can be implemented. As shown in FIG. 4, a first color resistor 231b, a second color resistor 232b and a third color resistor 233b can be located above both the reflection regions R and the transmission regions T of respect pixel units, so that the light transmitted by the transmission regions T, as well as the light reflected by the reflection regions R, exits from the color film substrate 210 through the color resistors. That is, the color resistors receive not only the transmitted light from the transmission regions T, but also the reflected light from the reflection regions R. Further, in order not to negatively affect the transmittance of the reflection regions R, the color resistors cover only a part of the reflection regions R.

Because light transmittance may vary with color, the areas of the resistors of different colors may be different. Generally, the covering areas of the color resistors corresponding to the reflection regions R may be as follows: the blue color resistor covers the largest area, the red color resistor covers the intermediate-sized area, and the green color resistor covers the smallest area.

Referring to FIGS. 3 and 4, there is no gap between the transmission region (or the transparent electrode) and the reflection region (or the reflection metal layer) of adjacent pixel units. As a consequence, the incident ambient light or the light from the backlight unit is either reflected on the reflection regions or transmitted by the transmission regions. That is, there is no non-display region between adjacent pixel units. Therefore, the pixel units of some embodiments have effective areas of the reflection regions which are increased without reducing the transmission regions, to improve the display quality of the reflection regions. Further, effective areas of the transmission regions of some embodiments are increased without reducing the reflection regions, to improve the display quality of the transmission regions.

In the Liquid Crystal Display device provided in the prescribed embodiments of the present invention, the display region of a pixel unit includes a reflection region and a transmission region, and the distance between the reflection region and the transmission region of adjacent pixel units is not more than 1 micrometer. That is, a reflection region or a transmission region is formed within the gap between adjacent pixel units. Such use of the gap between adjacent pixel units improves the utilization of display regions of the Liquid Crystal Display device. Therefore, the effective areas of the reflection regions can be increased without reducing the transmission regions, to improve the display quality of the reflection regions or, the effective areas of the transmission regions can be increased without reducing the reflection regions, to improve the display quality of the transmission regions. Therefore, the aperture ratio of the Liquid Crystal Display device is increased.

Further, the reflection metal layers are located on the surfaces of the third insulation layers, the transparent electrodes are on the surface of the second insulation layer, and the transparent electrode and the reflection metal layer of adjacent pixel units are electrically insulated by the third insulation layer. In the direction parallel to the array substrate, the distance between the transparent electrode and reflection metal layer of adjacent pixel units can be less than 1 micrometer, for example, 0 micrometer, so that no non-display region is formed between the adjacent pixel units. As a result, utilization of display regions in the Liquid Crystal Display device is maximized. Therefore, the effective areas of the reflection regions can be increased without reducing the transmission regions, to improve the display quality of the reflection regions, or the effective areas of the transmission regions can be increased without reducing the reflection regions, to improve the display quality of the transmission regions. Therefore, the aperture ratio of the Liquid Crystal Display device is increased.

Although certain embodiments of the present invention have been disclosed, embodiments of the present invention are not limited thereto. Those skilled in the art can make various changes and amendments without departing from the scope of the present invention.

What is claimed is:

1. A Liquid Crystal Display device, comprising:
an array substrate;
a color film substrate; and
a plurality of pixel units between the array substrate and the color film substrate, wherein each pixel unit comprises:
a reflection region, and
a transmission region,
wherein a distance between the reflection region of a first pixel unit and the transmission region of a pixel unit adjacent to the first pixel unit is less than or equal to 1 micrometer in a direction parallel to the array substrate.

2. The Liquid Crystal Display device of claim 1, wherein the distance between the reflection region of the first pixel unit and the transmission region of the adjacent pixel unit is 0 micrometer.

3. The Liquid Crystal Display device of claim 1, wherein a transparent electrode is formed in the transmission region, a reflection metal layer is formed in the reflection region, and the transparent electrode of the first pixel unit and the reflection metal layer of the adjacent pixel unit are electrically insulated.

4. The Liquid Crystal Display device of claim 3, wherein the transparent electrode and the reflection metal layer in the first pixel unit are electrically connected.

5. The Liquid Crystal Display device of claim 4, further comprising:
a first insulation layer on the array substrate;
a plurality of data lines located on the first insulation layer; and
a second insulation layer covering the data lines,
wherein the data line of the adjacent pixel unit is electrically insulated by the second insulation layer.

6. The Liquid Crystal Display device of claim 5, further comprising a third insulation layer on a portion of the second insulation layer, wherein the reflection metal layers are located on the third insulation layer, the transparent electrodes are located on the second insulation layer, and the transparent electrode and the reflection metal layer of the adjacent pixel unit are electrically insulated by the third insulation layers.

7. The Liquid Crystal Display device of claim 6, wherein the distance between the transparent electrode and the reflection metal layer of the adjacent pixel unit is not more than 1 micrometer in a direction parallel to the array substrate.

8. The Liquid Crystal Display device of claim 7, wherein the distance between the transparent electrode and the reflection metal layer of the adjacent pixel unit is 0 micrometer in the direction parallel to the array substrate.

9. The Liquid Crystal Display device of claim 3, wherein the transparent electrodes comprise indium tin oxide.

10. The Liquid Crystal Display device of claim 1, further comprising:
a plurality of color resistors on the color film substrate; and
a plurality of transparent electrodes covering the color resistors.

11. The Liquid Crystal Display device of claim 10, wherein light reflected by the reflection regions is transmitted through the color resistors.

12. The Liquid Crystal Display device of claim 11, wherein light transmitted by the transmission regions is transmitted through the color resistors.

13. The Liquid Crystal Display device of claim 3, further comprising a backlight unit, wherein light provided by the backlight unit is transmitted by the transparent electrodes and exits from the color film substrate.

14. A Liquid Crystal Display device, comprising:
a plurality of scanning lines;
a plurality of data lines; and
a plurality of pixel units formed near intersections of the scanning lines and data, wherein each pixel unit comprises:
a reflection region, and
a transmission region,
wherein a distance between the reflection region of a first pixel unit and the transmission region of a pixel unit adjacent to the first pixel unit is less than or equal to 1 micrometer.

15. The Liquid Crystal Display device of claim 14, wherein the distance between the reflection region of the first pixel unit and the transmission region of the adjacent pixel unit is 0 micrometer.

16. The Liquid Crystal Display device of claim 14, further comprising:
a plurality of color resistors; and
a plurality of transparent electrodes covering the color resistors.

17. The Liquid Crystal Display device of claim 14, wherein a transparent electrode is formed in the transmission region, a reflection metal layer is formed in the reflection region, and the transparent electrode of the first pixel unit and the reflection metal layer of the adjacent pixel unit are electrically insulated.

18. The Liquid Crystal Display device of claim 17, wherein the transparent electrode and the reflection metal layer in the first pixel unit are electrically connected.

19. The Liquid Crystal Display device of claim 17, wherein the transparent electrodes comprise indium tin oxide.

20. The Liquid Crystal Display device of claim 17, further comprising a backlight unit, wherein light provided by the backlight unit is transmitted by the transparent electrodes.
